(19) United States
(12) Patent Application Publication
(10) Pub. No.: US 2021/0264514 A1
(43) Pub. Date: Aug. 26, 2021

(54) METHOD AND SYSTEM OF CREATING AND MARKETING STORED VALUE

(71) Applicant: Christopher Eugene Elrod, Loudon, TN (US)

(72) Inventor: Christopher Eugene Elrod, Loudon, TN (US)

(21) Appl. No.: 16/798,398

(22) Filed: Feb. 23, 2020

(51) Int. Cl. G06Q 40/04; G06Q 30/04; G06Q 40/02; G06Q 20/36; G06Q 30/02; G06Q 30/06; G06F 9/54; G06F 16/23

(52) U.S. Cl. CPC G06Q 40/04; G06Q 30/04; G06Q 40/02; G06Q 20/36; G06Q 30/0238; G06Q 30/0633; G06F 9/54; G06F 16/2379; G06Q 30/0233

(57) ABSTRACT

The creation and marketing of a debtor-branded stored value by accepting an invoice or other presentment of debt can allow a variety of users to benefit during the point of sale experience.

### BACKGROUND OF THE INVENTION

Small business owners face numerous obstacles. For those that desire to be their own boss there is always the stress of earning enough money to keep the doors open, the lights on, and customers coming. To help offset cash expenses, many resort to barter through an exchange, trade with other business owners, or even become members of local cooperatives. If small business owners had the ability to empower one another, ensure future sales, and potentially increase their earnings every time they paid an invoice or other debt it could help eliminate their stresses and possibly change the dynamics of how they operate their business.

The present invention is a process which allows a debtor to create and market stored value that can be used as a method of payment during the point of sale. This process gives business owners that are purchasing a product or service the ability to offset the debt they have incurred with the creditor while potentially guaranteeing a future sales opportunity for themselves.

The present invention is in the field of business services with a primary emphasis on marketing.

The present invention is in the technical field of stored value payments.

### SUMMARY OF THE INVENTION

While the act of paying for goods and services with stored value is nothing new, the present invention is a process that occurs during the point of sale that allows a creditor to create a stored value payment on behalf of the debtor when a specific set of conditions are met. When this occurs, the present invention is simply a mechanism of action that can create a virtual “IOU” on behalf of the debtor, apply it to the transaction thereby offsetting the amount owed. Once the virtual “IOU” is created it is automatically applied to the transaction and deposited into the creditor's virtual wallet as a debtor-branded stored value. The completion of this process is confirmed by the generation of a receipt that reflects the amount of debtor-branded stored value that was created and applied to the transaction. The creditor can then redeem it with the debtor which will cancel the debt owed, or if they choose, the creditor can market the debtor-branded stored value by selling, trading, donating, or gifting it to another user. Regardless of the choice made by the creditor the ownership of the debtor-branded stored value is transferred to the new owner. If sold, any proceeds generated on behalf of the same are given to the original creditor. The new owner has now assumed the debt owed by the debtor and can recycle the debtor-branded stored value as method of payment with the debtor or continue the marketing process.

The present invention will have advancement over currently used systems and methods at least because it allows a creditor to create a stored value payment on behalf of the debtor, while also creating a sellable product for themselves that can be monetized to pay the debtor's obligation.

### BRIEF DESCRIPTION OF THE DRAWINGS

FIG. 1 is a flow chart of the method and process steps that demonstrate an overview of the method with its function, conditions, and output.

FIG. 2 is a flow chart of the method and process steps that demonstrate the application of the method that creates a debtor-branded stored value during the point of sale.

FIG. 3 is a flow chart of the method and process steps regarding how to the debtor-branded stored value may be used.

FIG. 4 is a flow chart of the method and process steps regarding the redemption and removal of the debtor-branded stored value.

### DETAILED DESCRIPTION OF THE INVENTION

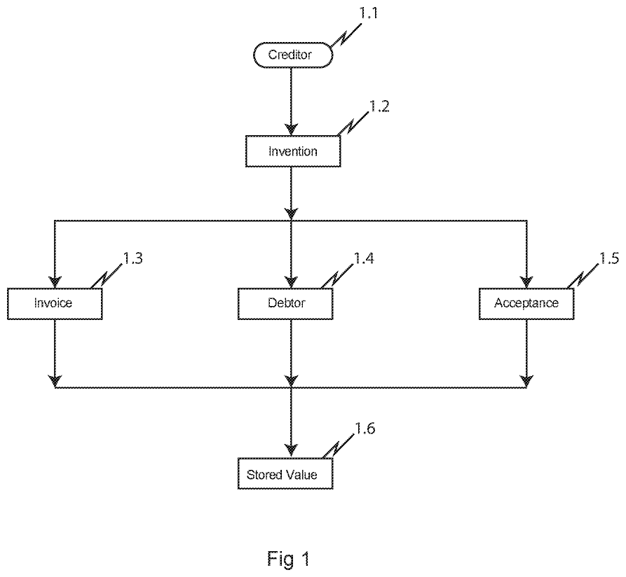

Referring now to the invention in more detail, in FIG. 1, there is shown a flow chart demonstrating a detailed description of the present invention in which a function and conditions results in an output where stored value is created from the acceptance of an invoice or other presentment of debt. The process begins with a creditor 1 engaging the present invention 2 to create three specific conditions: a creditor is generating or has generated an invoice 3 or presentment of debt from the use of the present invention 2, a debtor 4 has received an invoice 3 or presentment of debt from a creditor 1 that engaged the present invention 2, and has the debtor 4 accepted 5 the invoice 3 or presentment of debt generated from when a creditor 1 engaged the present invention 2. If all conditions are met then the present invention 2 will produce and apply stored value 6 sufficient to satisfy the invoice 3 or other presentment of debt created when the creditor 1 engaged the present invention 2.

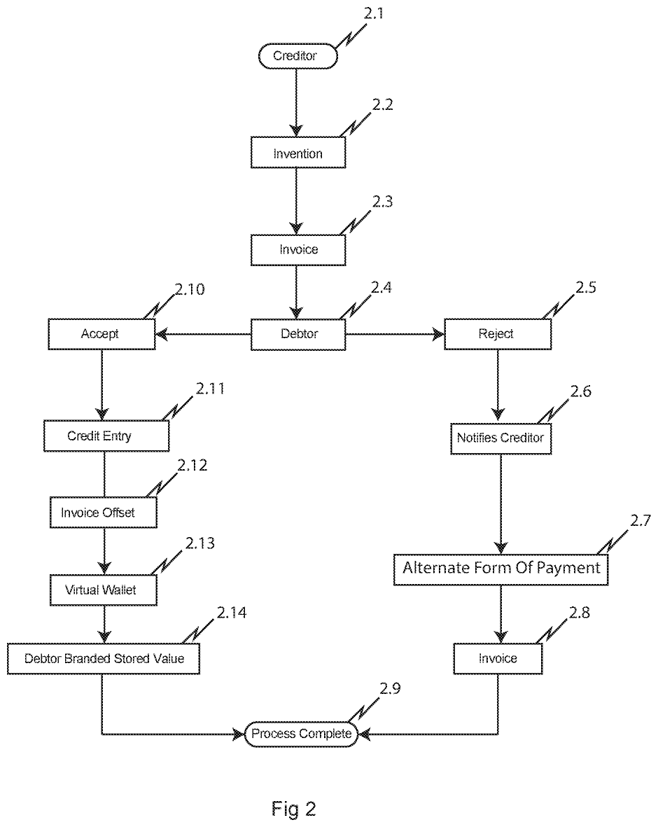

Referring now to the invention in more detail, in FIG. 2, there is shown a flow chart demonstrating a detailed description of the of the present invention which shows the creation of the debtor-branded stored value during the point of sale. The process begins when a creditor 1 uses the present invention 2 to generate an invoice 3 or other presentment of debt. When the creditor 1 creates the invoice 3 or other presentment of debt using the present invention 2 the debtor 4 will have to accept 10 or reject 5 the invoice 3 or other presentment of debt. If the invoice 3 or other presentment of debt is rejected 5 by the debtor 4 then the present invention 2 will notify 7 the creditor 1 of the rejection 5 and the debtor 4 must use an alternate form of payment 8 to pay the invoice 3 or other presentment of debt. After the alternate payment method is applied 7 the invoice is paid 8 and the payment process is completed 9. If the invoice 3 or other presentment of debt is accepted by the debtor 10, then the present invention 2 will a produce a credit entry 11 that will be used to offset 12 the invoice 3 that was created by the creditor 1. Upon offsetting the invoice 12 with the credit entry 11 the offsetting invoice is applied to the creditor's virtual wallet 13 and reserved as debtor-branded stored value 14 that is now owed by the creditor 1. The process completes 9.

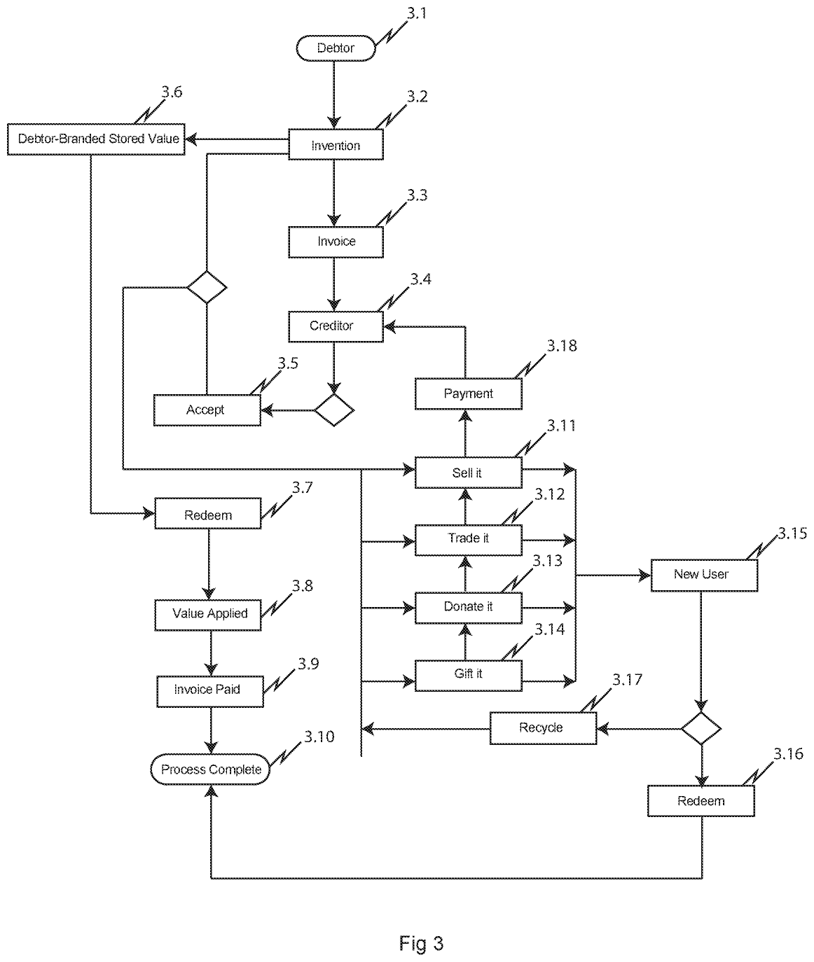

Referring now to the invention in more detail, in FIG. 3, there is shown a flow chart demonstrating a detailed description of the present invention regarding the usage of the debtor-branded stored value. The process begins with the debtor 1 that has engaged the present invention 2 to generate an invoice 3 or other presentment of debt to allow the creditor 4 to redeem their debtor-branded stored value being held within their virtual wallet 6. Upon the creditor's 4 acceptance 5 of the invoice 3 or other presentment of debt from the debtor 1 the present invention will initiate the creditor's virtual wallet to apply the debtor-branded stored value on behalf of the creditor 1. Upon redeeming 7 the debtor-branded stored value the present invention 2 will produce a ledger entry to apply the value 8 which will zero out the invoice 9 or other presentment of debt thereby completing the redemption process 10. Additionally, the creditor can sell 11, trade 12, donate 13, or gift 14 the debtor-branded stored value to another user 15. If sold 11, then any funds generated from the payment 18 receive for the purchase of the debtor-branded stored value is credited to the creditor 4. If not sold the new user can then recycle 17 the process or choose to redeem 16 the debtor-branded stored value with the debtor which will complete 10 the process of redemption 16. Regardless of the option selected both debtor 1 and creditor 4 have the ability to engage the present invention 2 to start the process anew.

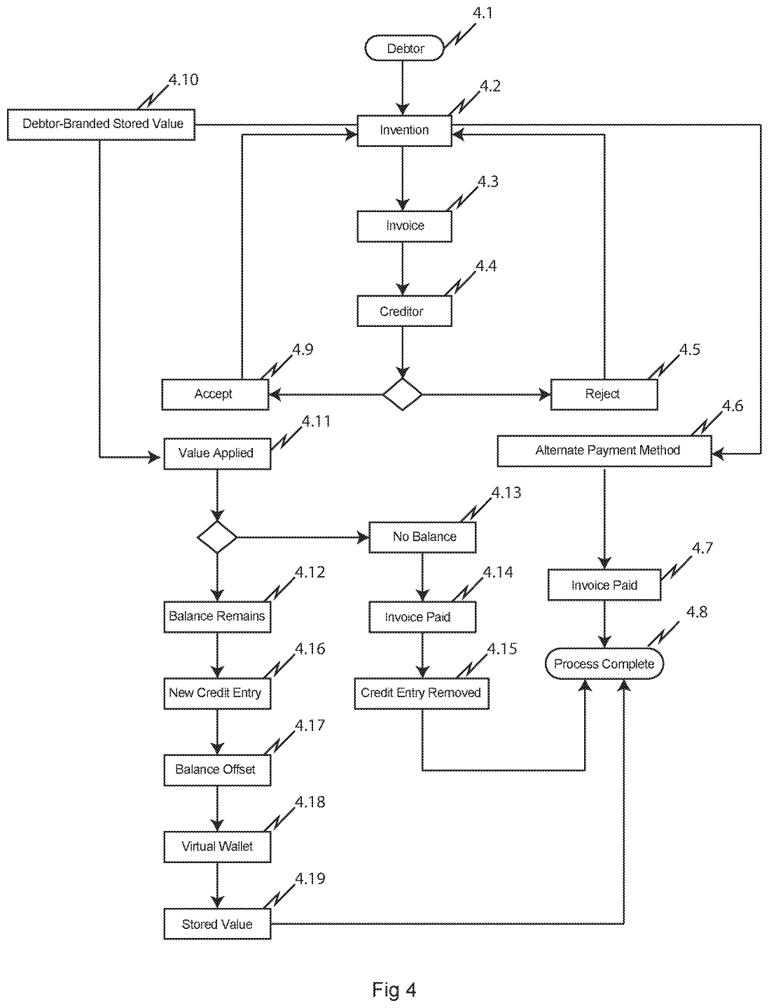

Referring now to the invention in more detail, in FIG. 4, there is shown a flow chart demonstrating a detailed description of the present invention regarding the redemption and removal of the debtor-branded stored value. The process begins with a debtor 1 engaging the present invention 2 to create an invoice 3 or other presentment of debt during the point of sale. After the creditor 4 receives the invoice 3 they must choose to accept 9 or reject 5 the invoice 3. If creditor 4 rejects 5 the invoice 3 or other presentment of debt the present invention 2 receives notice and another form of payment 7 will be used to pay the invoice 7 or other presentment of debt and complete the process 8. If invoice 3 is accepted 9 by creditor 4 then the present invention receives notice and looks for any debtor-branded stored value. If value is found 10 it is applied 11 to the invoice. If no balance remains 13 the invoice is paid 14 and the credit entry 15, that created the debtor-branded stored value, is removed and the process completed 8. If a balance remains 12 after value is applied 11 a new credit entry is initiated 16 and the balance due is offset 17. The offset balance 17 is transmitted to the virtual wallet 18 and reserved as stored value 19 thereby completing the process 8.

1. A system and method for creating a stored value from the acceptance of an invoice or other presentment of debt incurred from the purchase of a good or service, the process comprising of:
generating an invoice;
presenting an amount due;
acknowledging a debt by a debtor;
creating a credit entry;
transferring ownership of the credit entry to the creditor;
when placed in a virtual wallet the credit entry becomes debtor-branded stored value;
redeeming debtor-branded stored value like gift certificates;
utilizing a trading platform to exchange debtor-branded stored value;
a marketplace to sell the debtor-branded stored value;
the ability to donate or gift debtor-branded stored value;
initiating a transaction;
transmitting transaction data from initiator to a database administered by an administrator;
selling said value to a purchaser;
processing a sale with said presented debtor-branded stored value;
original debtor redeeming their branded stored value;
completing said sale;
creating a debtor-branded stored value in lieu of commission owed if applicable;
debt that can be offset or settled with debtor-branded stored value;
the process of selling, trading, donating, or gifting debtor-branded stored value created from the acceptance of an invoice or other presentment of debt can becoming self-perpetuating or self-eliminating.

2. A system and method for implementing and operating the present invention comprises:
a method, system or application capable of storing customer, product, sales, order, supplier, vendor, and any other pertinent data associated with the same;
a method, system or application capable of creating an order;
a method, system, or application capable of generating an invoice or an amount due;
a method, system, or application capable of converting an invoice or amount due into stored value;
a method, system, or application of storing value converted from the acceptance of an invoice or other presentment of debt owed by a debtor;
a method, system, or application with processing functionality that allows stored value to complete the payment for the order, payment for an invoice or other presentment of debt;
a method, system, or application utilizing a payment gateway that allows the transferring of the stored value from the buyer to the seller upon completion of the order;
a method, system, or application in which a virtual wallet is used to store value;
a method, system, or application which utilizes a marketplace to create, redeem, and sell stored value;
a method, system, or application which utilizes an advertising platform that displays, markets, and sells stored value to consumers;
a method, system, or application that utilizes a gift, loyalty, or rewards program that will allow stored value to be purchased, earned, redeemed, sold, transferred, or donated;

3. The application of claim 2 further allows the present invention to generate a debtor-branded stored value at and during the point of sale.

4. The application of claim 2 further allows the present invention to be implemented and operated within an application programming interface.

5. The application of claim 2 further allows the present invention to be implemented and operated within a shopping cart plugin or extension.

6. The application of claim 2 further allows the present invention to be implemented or operated within an electronic payment processing terminal, pin-pad device, card reader, payment gateway, tokenization service, EMV device, payment facilitator platform, or P2P payment services including but not limited to trade or bartering software or

7. The application of claim 2 further allows the present invention to be implemented or operated within a point of sale application, interface, or other Software-as-a-Service that provides point of sale, accounting, invoicing, checkout, gift, loyalty, or rewards functionality.

8. The application of claim 2 further allows the present invention to be implemented and operated within a website or electronic commerce (E-commerce), or block-chain environment.

9. The application of claim 2 further allows the present invention to be implemented or operated within a mobile, cellular, or smart television technology application.

10. The application of claim 2 further allows the present invention to be implemented within or operated by gaming or virtual reality software or applications.

11. The application of claim 2 further allows the present invention to create and market a debtor-branded stored value during the use of a trade or barter payment gateway, platform, service, software or application relating to the same.

12. The application of claim 2 further allows for marketing debtor-branded stored value using electronic and non-electronic forms of advertising media.
